(19) United States
(12) Patent Application Publication
(10) Pub. No.: US 2024/0193090 A1
(43) Pub. Date: Jun. 13, 2024

(54) CACHE STRUCTURE FOR HIGH PERFORMANCE HARDWARE BASED PROCESSOR

(71) Applicant: HYANNIS PORT RESEARCH, INC., Needham, MA (US)

(72) Inventor: Anthony D. Amicangioli, Newton, MA (US)

(21) Appl. No.: 18/532,373

(22) Filed: Dec. 7, 2023

Related U.S. Application Data
(60) Provisional application No. 63/430,835, filed on Dec. 7, 2022.
(60) Provisional application No. 63/430,777, filed on Dec. 7, 2022.
(60) Provisional application No. 63/430,778, filed on Dec. 7, 2022.

(51) Int. Cl. G06F 12/0877; G06F 12/0893

(52) U.S. Cl. CPC G06F 12/0877; G06F 12/0893

(57) ABSTRACT

A high performance computing system and methods, such as may be used to implement functions such as a matching book processor or data feed service. The system and methods organize data representing orders in a particularly efficient cache line structures referred to as tiles. The tiles each include order data for a given instrument, side, and price. The order data within each tile is further configured as an access node that includes minimal data needed to process the order. The array of access nodes is further organized into one or more prioritized collections of active and/or free access nodes.

### CROSS REFERENCE TO RELATED APPLICATIONS

This patent application claims priority to co-pending U.S. Provisional Patent Application Ser. No. 63/430,835, filed Dec. 7, 2022; U.S. Provisional Patent Application Ser. No. 63/430,777, filed Dec. 7, 2022; and U.S. Provisional Patent Application Ser. No. 63/430,778 filed Dec. 7, 2022. The entire content of each of these patent applications is hereby incorporated by reference.

### TECHNICAL FIELD

This application relates to high performance computing systems, such as may be used to implement a matching book processor or data feed service in an electronic trading system.

### BACKGROUND

An electronic order matching system also referred to as a Matching Engine (ME) is an electronic system that matches orders to buy and sell securities or financial instruments, such as stocks, futures, and commodities. When buyers and sellers are matched in the exchange of a particular financial instrument, a “trade” or “fill” transaction is created. The terms trade and fill are synonymous. For a given financial instrument, there is frequently a gap in price between the sellers' best (lowest) ask and the buyers' best (highest) bid on the book, which can result in orders not being immediately matched. Such unmatched orders are commonly called “resting orders,” as they rest on the book and are said to add liquidity or post liquidity. The term “book” is a legacy term that dates back to a time in which orders were tracked manually on paper “books” by humans, books that have since been automated in electronic datastores. Resting orders are stored until canceled or matched. Orders that are matched with resting counterparty orders are compounded/culminated into a “trade” event. The party that meets the resting liquidity is deemed to have removed liquidity.

U.S. Patent Publication US20150081508A1 describes a number of techniques for electronic trading systems. In the systems described, a user portal is provided for educational and informational purposes and also to assist investors in configuring their routing or trading preferences for electronic trading orders.

U.S. Patent Publication US20150073967A1 describes methods and systems for providing an electronic bidding order management infrastructure which receives and routes electronic trading orders from different trading entities at a server. A transmission medium is designed to create a certain amount of transmission latency before the trading orders can arrive at and be executed by electronic exchanges.

### BRIEF SUMMARY

It is well known that various technologies such as Field Programmable Gate Arrays (FPGAs), Application Specific Integrated Circuits (ASICs), Digital Signal Processors (DSPs), Reduced Instruction Set Computing (RISC), Advanced RISC Machine (ARM) and other embedded hardware technologies can be used to implement an array of hardware logic gates and/or be programmed to perform specified logic that operates at high speed. Such embedded hardware can significantly enhance execution speed as compared to general purpose processor-based platforms. When creating these hardware accelerated designs, the size of the dataset imposed by the application strongly affects maximum achievable performance. Hence, a critical consideration is to minimize the use of external memory. That is, for today's embedded hardware implementations a general rule of thumb is that it is difficult to build a system that operates in nanoseconds, unless the data model fits into the internal memory resources (known as block Random Access Memory (RAM)). For example, the dataset imposed by a Matching Engine Book (MEB) application or matching engine data feed service is by its nature large with heavy-tail randomness and requires the use of external memory.

Once a design imposes a requirement for external memory access, the next major considerations are both to minimize the number of memory access operations per application operation and to maximize the functional density of the data stored in external memory.

Another consideration when creating embedded hardware-based processors is to organize or situate the data in a manner that yields efficient “implied indexing” to said data. Intelligently defining how data collections are “spatially” organized can reduce additional indexing of data. Finding a way to minimize indexing and meta-data also minimizes the number of sequentially accessed memory structures.

Therefore, in one preferred embodiment, an electronic data processing system provides one or more market functions. The system includes at least one data processor that operates with one or more memory devices. At least some of the memory devices provide a cache memory that is local to the data processor, such as being located on the same semiconductor chip as the processor. The cache stores order data in the form of a tile structure that includes an array of smaller structures called access nodes. The access nodes represent an order for a given financial instrument (e.g., a stock symbol), a side (buyer or seller), and a price; the access nodes associated with a given instrument, side and price are preferably stored in the same single tile. One or more head and/or tail references further organize the access nodes of each tile into one or more prioritized collections. These prioritized collections may include active access nodes and/or free access nodes.

The access nodes may contain references to cell data structures that contain additional data that represent the orders.

The prioritized collections may be sorted based on one or more attributes of the access nodes such as via a sequence number, a time received, or a quantity.

The prioritized collections may be implemented as linked lists, where each access node includes a reference to a next access node or a previous access node.

The prioritized collections may also be implemented as doubly linked lists, where the doubly linked lists include the head and tail references and where each access node includes a reference to a next and a previous access node.

Two or more tiles can be stored contiguously and accessed via a single memory address.

In some implementations, the memory may include both off-chip DRAM and on-chip block RAM. In that instance, a tile move may include any combination of off-chip DRAM and on-chip Block RAM addresses. In other words, source addresses and destination addresses to access the memory include either an off-chip DRAM address or an on-chip Block RAM address, or both.

The tiles may be created with a predetermined size such that a collection of tiles can be stored and accessed as a larger array.

A tile can also contain a reference to another tile in a case where more than a predetermined number of access nodes associated with a given instrument, side and price are stored in a single tile. This extension of a tile can be performed dynamically with storage of additional access nodes.

A first access node contained within a tile can be accessed during an initial portion of a transfer operation for the tile, before the tile is completely loaded into a cache memory portion.

The free access nodes may be kept in order by indices into the array of access nodes.

An access node may be moved from one prioritized collection to another by rewriting the next and/or previous references.

The access nodes may contain an index or reference to cell data structures that store additional data representing the orders. The cell data structure is preferably a data structure that is separate from the tile data structure.

The system may be used to implement different types of financial functions such as a matching engine book or a market data feed appliance.

The processors may be implemented as Field Programmable Gate Arrays (FPGAs), Application Specific Integrated Circuits (ASICs), or other embedded hardware technologies.

Preferred embodiments may include a computer program product stored in a computer-readable medium. The computer program product may consist of sets of instructions for receiving access node data structures, with each access node referencing a cell data structure representing order data associated with an instrument, side and price. Other instructions insert the access nodes into one or more tiles, where each of the tiles include an array of the access nodes for a given instrument, side, and price; metadata fields that relate to additional order data for the given instrument, side, and price; and at least a head and a tail reference organizing the access nodes in the array into one or more prioritized collections. Still other instructions may process the array of access nodes to execute a market function.

Preferred embodiments of the system may also include an electronic data processing system that executes methods that implement selected features described above. For example, one or more data processors may access one or more memories to configure one or more tile data structures. The memories may include an on-chip Block Random Access Memory (Block RAM) located on a semiconductor chip with at least one of the data processors, and an off-chip Dynamic Random Access Memory (DRAM).

Each of the one or more tiles may contain an array of access nodes that represent orders for a particular instrument, side and price (ISP); and one or more head and/or tail references that organize the access nodes into one or more prioritized collections of active access nodes and a collection of free access nodes.

At least one of the one or more data processors is further configured for receiving a request for an access node at a given ISP; loading a tile for the given ISP from the DRAM into the Block RAM; locating in the Block RAM the requested access node in the tile for the given ISP loaded in the Block RAM; and returning from the Block RAM the requested access node from the tile for the given ISP loaded in the Block RAM.

In such a system, the one or more data processors may be further configured for moving the requested access node from the one or more prioritized collections of active access nodes to the collection of free access nodes, such that the moving includes modifying in the Block RAM at least one reference in the one or more head and/or tail references.

The system may also associate a request for an access node at a given ISP with a new order. In that instance, the system may then locate in the Block RAM the requested access node in the tile for the given ISP by further locating in the Block RAM in a first prioritized collection of the one or more prioritized collections an access node via the one or more head and/or tail references.

The one or more data processors may be further configured to perform additional steps such as receiving a second request for a second access node at the given ISP, the second request being associated with the new order; locating in the Block RAM the requested second access node in the tile for the given ISP, the locating further comprising locating in the Block RAM in the first prioritized collection a second access node via the one or more head and/or tail references; and returning from the Block RAM the second requested access node from the tile for the given ISP loaded in the Block RAM.

The one or more data processors may also be configured for receiving a second request for a second access node at the given ISP, the second request being associated with the new order; locating in the Block RAM the requested second access node in the tile for the given ISP, the locating further comprising locating in the Block RAM in a second prioritized collection a second access node via the one or more head and/or tail references; and returning from the Block RAM the second requested access node from the tile for the given ISP loaded in the Block RAM.

In some embodiments, The given ISP may include a given instrument, a given side, and a first price; the tile at the given ISP may comprise a first tile; and the one or more data processors may be configured to perform additional steps of: receiving a second request for a second access node at the given ISP, the second request being associated with the new order; loading a second tile from the DRAM into the Block RAM, the second tile being associated with the given instrument, the given side, and a second price; and while the first tile comprises no active access nodes in the one or more prioritized collections in the first tile, then: locating in the Block RAM the requested second access node in the second tile, the locating further comprising locating in the Block RAM in a prioritized collection of the one or more prioritized collections in the second tile a second access node via one or more head and/or tail references in the second tile; and returning from the Block RAM the second requested access node from the second tile loaded in the Block RAM.

The one or more data processors may start loading the second tile prior to receiving the second request for the second access node.

In some embodiments, each access node is uniquely identified by the given ISP and an index value into the array of access nodes. In that instance, the step of receiving a request for an access node at a given ISP further comprises receiving a request for an access node at a given ISP and a given index value, the request for the access node being associated with an order cancel request; and the step of receiving locating in the Block RAM the requested access node in the tile for the given ISP further comprises locating in the Block RAM the access node having the given index value in the array of access nodes.

Furthermore, loading the tile for the given ISP from the DRAM into the Block RAM may be performed prior to receiving a request for an access node at the given ISP.

### BRIEF DESCRIPTION OF THE DRAWINGS

Features and advantages of the approaches discussed herein are evident from the text that follows and the accompanying drawings, where:

FIG. 1 illustrates a high level diagram of a trading system;

FIG. 2 is a more detailed diagram of a Matching Engine Book (MEB), including an Open Order DataBase (OODB) containing cell objects, Book Processing Logic, an Interconnect Interface, and a Cache that contains access nodes associated with cell objects; and

FIG. 3 shows an example of an OODB 170 where each cell object has a Global Sequence Number (GSEQ) and an associated index (IDX) of a corresponding access node data element that points to a cell via its associated GSEQ.

FIG. 4 shows an example access node array 290 stored within a tile data structure 250 as stored in memory in more detail.

FIG. 5 illustrates the same example tile data structure and its one or more linked lists of access nodes.

FIG. 6 is a flow diagram that illustrates a method according to some embodiments of processing a request for an access node.

FIG. 7 is a flow diagram further illustrating that method.

FIG. 8 is a schematic diagram that illustrates an embodiment of an automated trading system, including a ticker plant that maintains a separate order book.

FIG. 9 is a schematic diagram that illustrates another embodiment of an automated trading system, including a ticker plant that maintains a separate order book.

### DETAILED DESCRIPTION OF PREFERRED EMBODIMENT(S)

Electronic trading systems, and particularly order matching engines that execute orders to buy and sell stock and other financial instruments, are extremely latency sensitive environments. To enhance order execution speed, an electronic trading system is disclosed herein that can be implemented using field programmable gate arrays (FPGA), application-specific integrated circuits (ASIC), or other fixed logic. FPGAs, ASICS, and other fixed logic generally execute operations faster than central processing unit (CPU)-based platforms. However, electronic trading systems must handle large data sets, for example, what are sometimes referred to as “an order book.” The data sets of an order book often include a highly variant number of buy and sell orders per price point for each financial instrument. Therefore, order book data sets are generally incapable of fitting into internal memory caches of FPGAs, ASICs, and other fixed logic.

External memory caches, such as dynamic random access memory (DRAM), may be used to better accommodate the large data sets of an order book. However, memory access in FPGA designs can be expensive in terms of delay, particularly when large datasets impose the use of external DRAM. DRAM is relatively slow on initial access and only becomes efficient with sequential access. In an FPGA, read/write memory access operations to internal memory caches, such as Block Random Access Memory (BRAM), are generally faster than read/write memory access operations to external DRAM.

To address the foregoing challenges, embodiments of an electronic trading system disclosed herein are configured to minimize the number of external memory accesses, and thereby minimize memory access delay. For example, order data for all open orders of a particular instrument, side, and price (“ISP”) may be organized into a defined data structure (referred to herein as a “tile”) that can be fetched from an external memory cache. Once loaded into the internal memory cache of an FPGA or other fixed logic, the tile may be accessed often with minimal delay in order to obtain order data for multiple open orders having the same instrument, side, and price. Accordingly, an external memory cache can be accessed once to obtain a tile containing the order data for all open orders having the same instrument, side, and price as opposed to accessing an external memory cache multiple times to obtain data separately for each individual order.

In some embodiments, the external memory cache allocates a predetermined amount of space for each tile associated with each given instrument, side and price regardless of the number of active orders associated with that ISP. Since separate cache space is allocated for each such tile, tile locations may be easily indexed according to price using a symbol registry that defines the boundaries of a contiguous memory segment.

The electronic trading systems and methods described herein involve several design considerations as follows:

The tile data structure integrates data indexing (in the form of priority lists) and payload (arranged as an array of objects called access nodes, each storing data associated with a particular open order) which greatly reduces aggregate latency by combining both indexing and payload into a single tile, yielding a single-access design.

Additionally, the design maximizes the space efficiency in a tile by only including in the tile the most relevant order data needed for matching operations. More particularly, the design stores data representing a normalized trading event, or “order data instance, in a data structure called a cell. Each cell includes dynamic data fields and static data fields. The dynamic data fields are the fields in the cell that are required by a Matching Engine Book (MEB) processor to perform its operations. Dynamic data in the cell may include fields such as Quantity, Order-type, minimum-shares tradeable and so on. Static data are those items not used by the MEB for trading operations but required by other system elements, such as client defined free form fields. Separating the dynamic/relevant data from the cell and creating an access node using only the dynamic data fields further allows for maximizing the number of trading events stored in the tile per unit byte.

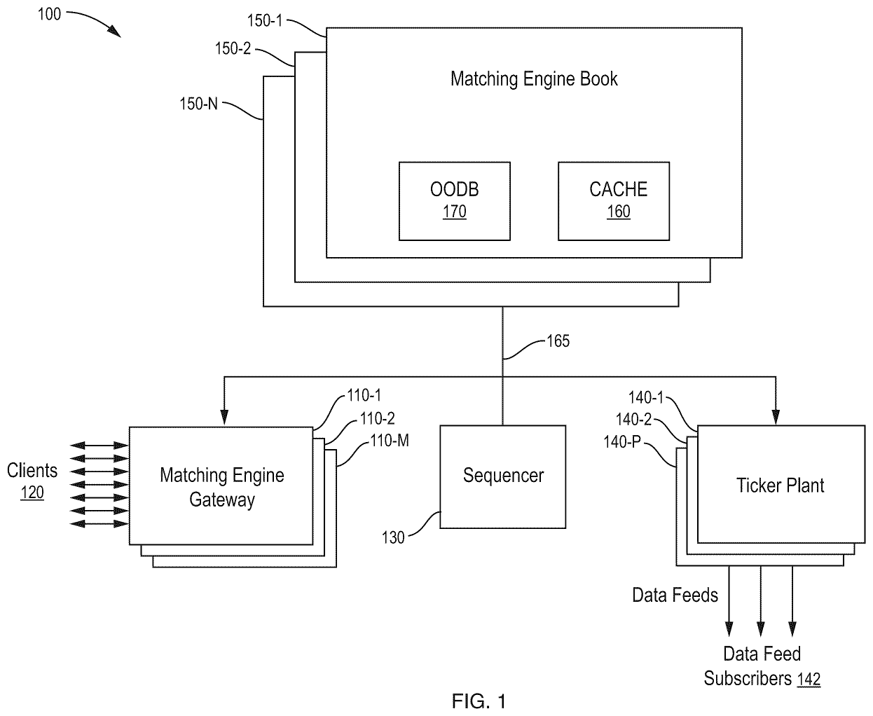

FIG. 1 is a diagram that illustrates an example system 100 that achieves these goals. As shown, the system 100 may include one or more client gateways 110-1, 110-2, . . . , 110-M (collectively referred to as client gateways 110), a sequencer 130, one or more data feed delivery systems or ticker plants 140-1, 140-2, . . . , 140-P (collectively, ticker plants 14), and one or more Matching Engine Book (MEB) processors 150-1, 150-2, . . . , 150-N (collectively, MEBs 150). Trading clients 120 (i.e., “market participants”) exchange trading messages (i.e., “trading events”) with the system 100 via the client gateways 110. The ticker plants 140 provide data feeds related to the exchange of financial securities to data feed subscribers 142. In a preferred embodiment, the system 100 provides a novel multi-modal cache structure 160 for a high performance hardware-based processor, such as a hardware-based Matching Engine 150 or a hardware-based ticker plant 140 that provides a data feed service. In particular, the system 100 utilizes a highly efficient structure for the cache 160 that enables superior throughput and reduced latency for processing orders stored in an Open Order DataBase (OODB) 170.

In the embodiment of FIG. 1, one or more Matching Engine Book (MEB) processors 150 form the core of a matching engine embodiment of the system 100, receiving trading messages that represent orders to buy or sell financial instruments from market participants (clients 120). The one or more MEB(s) 150 receive and send these messages as normalized trading events to/from other ME components connected to it via a system area network or similar interconnect(s) 165.

The trading messages may consist of orders, cancels, or replaces to place, remove, or modify requests to buy or sell financial instruments, respectively. Orders to buy or sell a corresponding instrument that are unable to be matched with a counterparty may be stored in the MEB's 150 internal datastore, deemed to be “resting orders,” and are also referred to as posted liquidity. Alternatively, when an order is matched with a counterparty that previously posted liquidity on the opposite side, for example, when a buyer is matched with a seller, the two orders are matched and joined to form a trade/fill.

Such trading events, resting adds or matching removes are reported back through the system interconnect through order acknowledgments (regardless of whether any part of the order rests) or trade reports (in the case of matches or fills). An order which matches might generate two outbound messages: an acknowledgement and a fill. Order data, including trading data related to resting orders and/or fills, may also be reported to other systems via the Ticker Plant 140 or other data feed service.

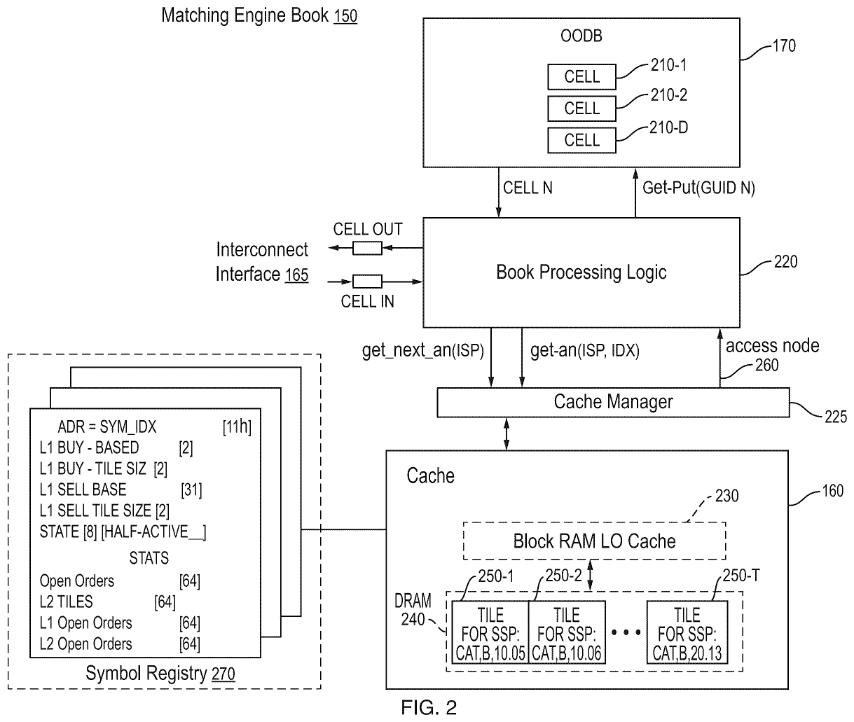

Referring to FIGS. 2, 3 and 4 may assist with the following discussion. As shown in those figures, in the preferred embodiment, trading messages may be represented as instances of a normalized data structure called cells 210-1, 210-2, . . . , 210-D (collectively/generically referred to as cells 210. Cells 210 contain information required for a financial transaction, a single “order data instance”, to be processed by the system 100. This data structure used for cells 210 is preferably used in common through all components of the system 100. The data in a cell 210 may be organized into two sub-sets: i) dynamic 320 and ii) static 310 information. Static information 310 is information such as a client defined order token that is required by other (non-MEB) components, but is not required by the MEB 150 to perform matching transactions.

Dynamic data 320 are the fields in a cell 210 required by the book processing logic 220 to perform trade matches. Examples of dynamic fields 320 include items such as quantity, order modalities (order types, controls) as well as other items such as account ID which is used for self-trade prevention. Cell dynamic data 320 is preferably organized in a separate structure called an access node 260.

When orders are received by the MEB 150 that do not completely match a contra party (as an order may partially match), the remaining orders will rest. Data representing such resting orders are stored in a distributed fashion, in which the overall (larger) cell static data are stored in an MEB data store known as the Open Order Database (OODB 170). The dynamic data, the so-called access node 260, from the cell 210 is replicated and stored in a caching system called the access node cache 160 (or simply the “cache” 160).

The system 100 further organizes the access nodes 260 into structures or containers called tiles 250. These tiles 250 should be arranged such that there is one and only one tile 250 per financial instrument (e.g., a stock symbol), per side (i.e., buy or sell) and per price (abbreviated herein as Instrument/Side/Price or “ISP”). Each tile 250 thus includes an array 290 of access nodes 260, with each access node 260 representing one open order for that ISP. The aim is to have all access nodes 260, that is, all the dynamic order data needed by the book processing logic to perform trading, for all open orders for a particular ISP to be included in a single tile 250.

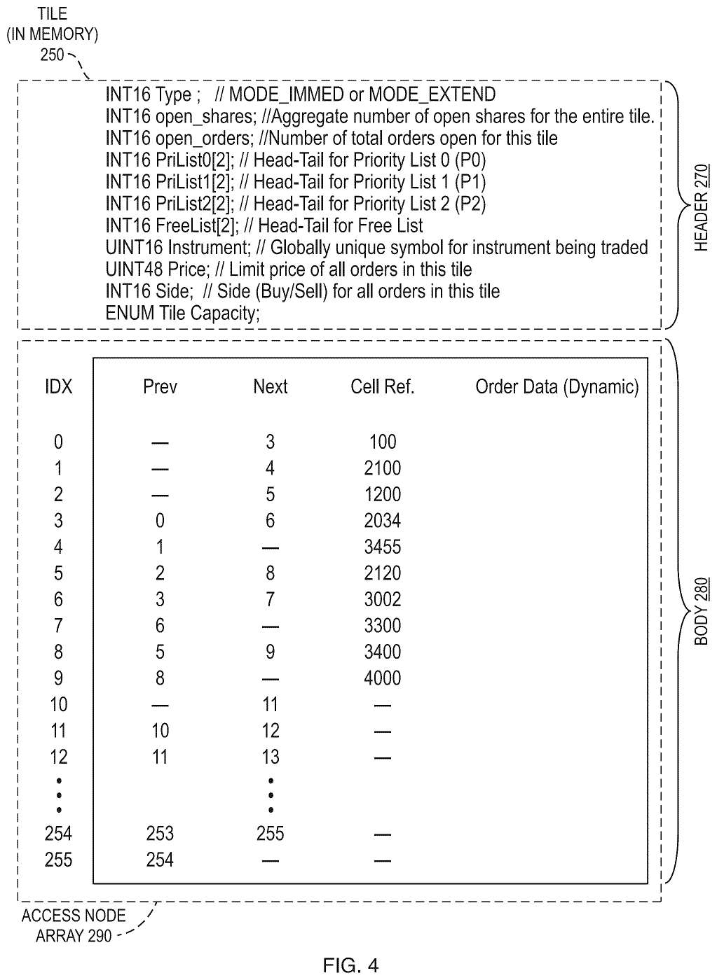

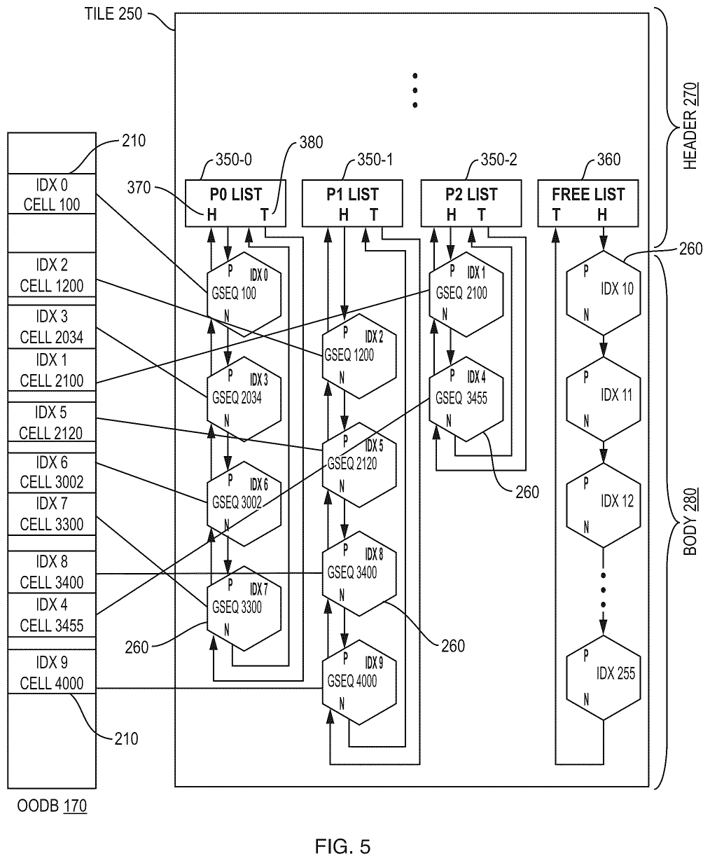

The access nodes 260 in each tile 250 are arranged in one or more priority linked lists based on a priority of the underlying order. Priority lists in the preferred embodiment determine the sequence in which matching orders will be paired with counterparty order fill requests. Tiles 250 and their associated priority lists 350 are described in connection with FIGS. 4 and 5 in more detail below.

FIG. 2 is a more detailed diagram of example components of a Matching Engine Book (MEB) 150 including an interconnect interface 165, Book Processing Logic (BPL) 220, cache manager 225, the Open Order DataBase (OODB) 170, and an access node cache 160.

The interconnect interface 165 receives cells 210 from other components of the system 100, such as the sequencer 130, and sends the cells 210 to the BPL 220 for further processing. Outgoing messages from the MEB 150, such as order acknowledgements, rejects, and fills may also be received by the interconnect interface from the BPL 220, and may in turn be sent in cell format to other components of the system 100 over the system interconnect 165.

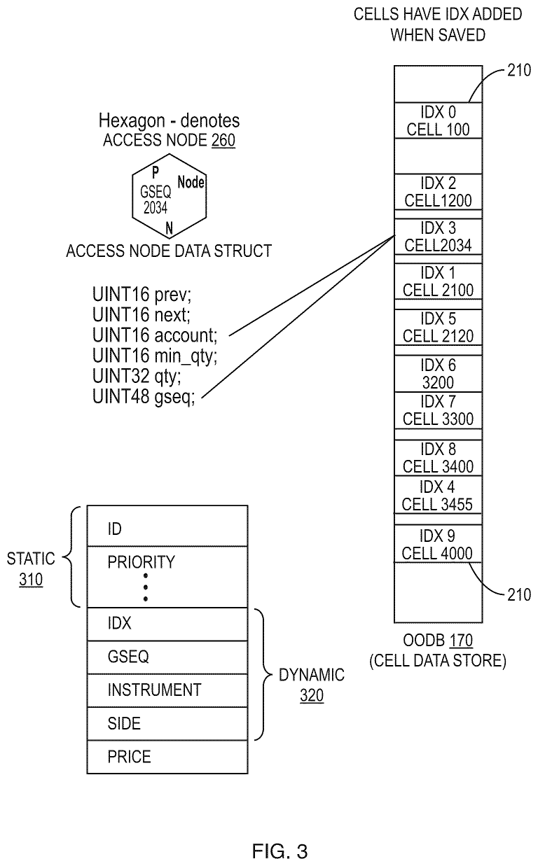

The BPL 220 interfaces with the OODB 170 to perform accesses such as put (write), delete, and get (read) the cells 210 it receives that correspond to resting orders. The OODB 170 may store cells 210 in an external data store (as described in connection with FIG. 3).

The BPL 220 contains processing logic to perform order operations such as, but not limited to, fills and cancels. The BPL 220 coordinates access to the resting order book with the cache 160.

The cache 160 stores dynamic trading data from the cells 210 in smaller structures, namely the access nodes 260, which are then organized and cached in tiles 250 for indexing and prioritizing the open orders corresponding to cells 210 in the OODB 170.

The cache manager 225 provides an interface to the BPL 220. The cache manager 225 enables the BPL 220 to perform operations using data in the access nodes 260 without the need for the BPL 220 to have any knowledge of the structure of the tile 250 or details of the cache 160. For example, some embodiments of the cache manager 225 may include an interface (“get_next_an”) in which the BPL 220 may provide an instrument, symbol, and price (ISP) to the cache manager 225 to return from the cache 160 the “next access node” at that ISP that may be used to match against a counter-order in a fill.

Some embodiments of the cache manager 225 may also include an interface (“get_an”) in which the BPL 220 may provide an ISP tuple and an identifier for a specific access node 260 (i.e., an “access node index,” discussed further below). In response thereto, the cache manager 225 then obtains a specific access node 260 from the cache 160. This second “get_an” interface may be useful in situations such as a cancel request, in which the specific known access node 260 is to be fetched.

The “get_next_an” and “get_an” operations implemented by cache manager 225 are described in more detail below.

While the embodiment shown in FIG. 2 is described in terms of an MEB system 150, it should be understood that a Ticker Plant system may in some embodiments include many of the same components. For example, like an MEB system, a Ticker Plant may include an interconnect interface to send and/or receive cells, a data store such as the OODB, and a caching system such as the cache 160 and cache manager 225 for efficient access to trading data including data regarding resting orders.

One or more components of the Ticker Plant 140 or of the MEB 150, such as the BPL 220, OODB 170, or the cache manager 225, may be implemented in some embodiments, at least in part, by fixed logic, such as via a Field Programmable Gate Array (FPGA), Application-Specific Integrated Circuit (ASIC) or other custom logic. It should be understood that embodiments described herein as being implemented via an FPGA could also be implemented via other fixed digital logic such as an ASIC or custom logic. Still other implementations may use high performance programmable processors such as Digital Signal Processors (DSPs), Reduced Instruction Set Computing (RISC), Advanced RISC Machine (ARM) to execute custom logic at high speed.

In embodiments in which the cache manager 225 is implemented in fixed logic such as an FPGA, the cache 160 may include a small but relatively fast cache memory implemented in internal FPGA Block memory (termed “Block RAM LO Cache” 230 herein), along with one or more larger but relatively slower external memories, illustrated in FIG. 2 for simplicity as a single external memory. This external memory may be implemented using Synchronous Dynamic Random Access Memory (SDRAM) technology or some other type of Dynamic RAM (labelled “DRAM” 240 in FIG. 2).

It should be understood that embodiments of the memory cache 160 may be provisioned in a single physical DRAM semiconductor chip or two or more DRAM chips.

FIG. 2 also shows this external memory storing a number of tiles 250-1, 250-2, . . . 250-T (collectively, the tiles 250), each tile 250 associated with a specific ISP tuple. The cache manager 225 may efficiently fetch a tile into the Block RAM LO Cache 230 from the slower DRAM 240 as needed by the BPL 220 to perform match processing on the access nodes in that tile 250.

Also stored in FPGA Block RAM 230 for fast lookup may be a Symbol Registry 270 which allows the cache manager 225 to quickly identify the memory location of a tile 250 as a function of its associated ISP. This is possible, for example, in embodiments in which tiles are stored contiguously in sequential order based on a price increment (for example, one tile for each $0.01 increment in price), and in particular in embodiments in which the tiles 250 are all of the same size (for example, each tile may hold 256, 512, or 1024 access nodes 260).

In some embodiments, each tile 250 contains all data needed by the BPL 220 to perform order match processing, including (as discussed further below) not only the dynamic data for all orders of a given symbol, side, and price, but also metadata statistics, order indexing and prioritization information for those orders. Having all such relevant data in the tile 250 already loaded in the on-chip Block RAM 230 cache allows for extremely fast processing of order matching by the BPL 220.

It should be understood that the discussion above applies to different embodiments of the system 100, whether they be a matching engine 150, a market data feed implemented by ticker plant 140, or some other high performance financial system application, for example.

### MEB Data Model—Cells, Access Nodes and Tiles

The MEB uses a data model illustrated in FIGS. 2, 3, 4 and 5 including the aforementioned cells 210, access nodes 260, and tiles 250. The data model may optimize the following design goals:

Latency Budget—Keep total MEB processing period to a minimum.

Single or Minimum Memory Access per MEB operation.

Ability to deal with exceptional situations such as excessive order quantity while maintaining other targets.

FIG. 4 shows an example of a tile 250 including a tile header 270 (discussed at greater length below) and a tile body 280. The tile body 280 includes an access node array 290 consisting of a set of access nodes 260 as stored in memory, such as the Block RAM 230 or DRAM 240. Each access node 260 is a predetermined size. Note also that the access nodes 260 are contiguously stored in memory. So, for example, any particular access node in the access node array 290 can be located via an index number, for example, by multiplying its index number times the size of each access node and adding the address of the first access node 260. The access node array 290 in this example consists of a total of 256 access nodes. However other sizes of access nodes 260 and access node arrays 290 are possible. Example access nodes 260, and in particular how they are also accessible via one or more linked lists, are described in more detail elsewhere in this document.

FIG. 5 shows an example of a tile 250 in more detail. Tile 250 comprises multiple active access nodes 260, each of which is associated with a cell 210 as stored in an OODB 170 (labelled as the “Cell Data Store” in FIG. 3).

A cell 210 is a fixed size data structure representing a normalized trading event. The cell 210 structure is common to multiple components of the ME system, including the MEB 150. Each cell 210 has a trading-day unique Global identifier, or Global Sequence Number (GSEQ). This GSEQ may be an ingress time-based value or other unique identifier, and may be inserted into the cell 210 by the sequencer 130 before the cell 210 arrives at the MEB 150. Cells 210 that represent resting orders may be stored in a data store in the MEB such as the OODB 170, and may be identified via their GSEQ.

As mentioned briefly above, the data in a cell 210 may be organized into two sub-sets: i.) dynamic information 320 and ii.) static information 310. The dynamic data 320 are the subset of fields in the cell 210 required by the book processing logic in the MEB to be available on a per order basis to perform trade match processing. The static data 310 may be everything else associated with a transaction, including client provided data, such as a Client Order ID.

In the embodiment of FIG. 3, the dynamic data within a cell 210 may be replicated in an access node (AN) structure stored in the access node cache 160. The access nodes 260 are represented as hexagons in FIG. 3 and in FIG. 5. The access node 260 structure enables more efficient trade match processing. In some embodiments, the static data may be significantly larger than the dynamic data. Thus, by replicating the dynamic data in the cache 160, it is possible to maximize the speed at which data relevant for match processing may be retrieved, by using the access nodes 260 for that purpose. Furthermore, storing access nodes associated with a given ISP in a single tile facilitates more efficient access for processing a large number of trading events. Once trades/fills occur, the dynamic data (in the cache 160) can then be rejoined with the static data (i.e., the data that was retained in the associated cells 210) to form a complete fill transaction.

Conceptually, the dynamic data stored in an access node 260 may be considered a subset of the data in its associated cell 210. In other words, the access nodes are a “stripe”, if you will, of memory comprising the dynamic data 320 within the OODB. As shown in FIGS. 4 and 5, an access node 260 may include several fields, including a mode field, a previous field, a next field, and selected data from the associated cell such as an account field, a minimum quantity field, a quantity field, and a global sequence identifier (GSEQ).

In some embodiments (including the embodiment of FIG. 3), some of the dynamic data 320 may therefore be obtainable from the cache 160 without requiring all the dynamic data 320 to be stored on a per access node 260 basis. For example, the symbol, side, and/or price need not be stored in each access node 260 itself, but may be stored in a different portion of the tile 250, for example, in the tile header 270, since the symbol, side, and price are common to all access nodes stored in a given tile. This approach may further optimize utilization of the cache 160.

Therefore, in the embodiment of FIG. 3, each resting open order in the MEB system is represented by a unique access node 260 in the associated tile 250 and also represented as a unique cell 210 as stored in the OODB. These two representations of the same order are linked, and thus one can be located from the other, using the global sequence (GSEQ) identifier.

The following table is a list of some example fields in a cell 210. The table includes a description of the cell 210 fields, whether they may be classified as static or dynamic data, and for dynamic data, where that data may be stored (e.g., in an access node 260 vs. a tile header 270). It should be understood that additional or different fields may be included. Furthermore, some embodiments may classify which fields are dynamic versus static in a different manner, and/or may store the dynamic data in different locations within the cache 160.

| | | Dynamic Data | |
|---|---|---|---|
| Field | Data Type | Location | Description |
| Message type | Static | N/A | The enumerated message type of this trading event. |
| Client Order ID | Static | N/A | Client provided identifier for this particular order. |
| Priority | Static | N/A | The order priority. Orders of higher priority may be |
| | | | matched regardless of time of entry. |
| Access Node | Dynamic | CELL/TILE | Index number of the associated access node in the tile |
| Index | | | corresponding to the order's side-symbol-price. |
| Price | Dynamic | TILE header | The order price sent by the client. |
| Side | Dynamic | TILE header | The side of the order (i.e., Sell/Ask or Buy/Bid). |
| Symbol | Dynamic | TILE header | Identifier for the symbol or financial instrument |
| | | | associated with this order. |
| Global sequence | Dynamic | Access node | Global sequence number of the individual cell set by the |
| | | | sequencer server. |
| Account | Dynamic | Access node | Identifier for account or client associated with this order. |
| Quantity | Dynamic | Access node | The total order quantity, not counting any quantity filled. |
| Minimum quantity | Dynamic | Access node | The minimum quantity of the order to be executed. |

As shown in FIG. 3, each access node 260 also includes fields for previous and next pointers that define its priority list membership within its associated tile. An access node 260 may therefore have the following structure:
Struct access_node {
UINT16 prev;
   UNIT16 next;
   UNIT16 account;
   UINT16 minqty;
   UNIT32 qty;
   UINT48 gseq;
}

As discussed above, each cell 210 may be identified by a trading-day unique Global identifier (GSEQ). This GSEQ may also be included in the access node 260 (e.g., as the “gseq” field above) to serve as a reference to that specific cell 210.

Similarly, each access node 260 may be identified by an index number (“access node index” or “IDX”). The access node index 265 is an identifier for an access node. Because access nodes are each of a fixed size, the access node index 265 represents an index or offset into the tile structure that represents the location of the access node 260 within the memory allocated for the tile. According to some embodiments, the access node index 265 may be independent of the physical memory location of the tile that contains the associated access node 260. In such embodiments, any access node 260 may be uniquely identified throughout the MEB with a combination of the ISP and the access node index 265.

The access node index 265 may be included in the cell 210 object as stored in the OODB as an added reference to the access node index 265 that the cell was assigned when cached.

These two references (i.e., the cell's GSEQ stored in the associated access node 260 and the access node index 265 stored in the associated cell 210) may thus form a “double link” between an access node 260 and the corresponding cell 210 in the OODB.

To summarize the relationship between a cell 210 and an access node 260:

Resting Open Orders may have distributed state in both an access node 260 and a cell 210. Resting open orders may have precisely one cell 210 in the OODB and may have one corresponding access node 260 stored in the cache 160. The access node 260 and cell 210 may be mutually linked. Cells 210 reference their unique access node 260 through the ISP and access node index 265 tuple. Access nodes reference their constituent cell 210 via the globally unique GSEQ.

The access node 260 may be the sole source of dynamic order state—Open order fields required to perform operations on open orders (price, quantity, etc.) are sourced from the access node 260, rather than the cell 210, and stored in the access node 260 when changes occur. For example, if a resting order is filled through multiple contra orders, the changing executed quantity is stored in the access node 260 but not updated in the cell 210.

The cell 210 may be the sole source of static state (order metadata). Static metadata is used solely to assemble outbound messages such as Fills or acknowledgements. The only dynamic data stored on the cell 210 may be the access node 260 index (IDX value)—which is used to serve as a reference to the access node 260. Hence, a cell 210 need only be written to the OODB when created and may later be cleared (freed) when the order is closed.

As discussed above, access nodes may be stored in the cache 160 in data structures called tiles. An example tile 250 is shown in FIGS. 4 and 5. A tile 250 is a multi-modal cache data structure containing all active access nodes 260 having the same instrument-side-price (ISP) tuple, metadata statistics for those access nodes, one or more prioritized lists 350 for those access nodes, and a freelist 360 for unused access nodes. There is precisely one active tile for any ISP tuple with zero or more open orders. Tiles 250 are designed to achieve optimum space-time optimization of the cache 160 memory.

The struct listed below may represent a tile 250 according to one embodiment:
Struct packed tile{
// tile header:
INT16 Type; // MODE_IMMED or MODE_EXTEND
INT16 open_shares; //Aggregate number of open shares for the entire tile.
INT16 open_orders; //Mumber of total orders open for this tile
INT16 PriList0[2]; // Head-Tail for Priority List 0 (P0)
INT16 PriList1[2]; // Head-Tail for Priority List 1 (P1)
INT16 PriList2[2]; // Head-Tail for Priority List 2 (P2)
INT16 FreeList[2]; // Head-Tail for Free List

UINT16 Instrument; I/A per Matching Engine Book processor globally unique symbol for the instrument being traded (such as a stock symbol).

UINT48 Price; // The limit price of all orders in “this” tile.

INT16 Side; // Side (Buy/Sell) for all orders in this tile.
ENUM Tile Capacity;
// tile body:
   Union {
      an_array[256], // for type MODE_IMMED—a function of the tile size
      Uint32 indirect address. // for type MODE_EXTEND—reference to a larger tile
      }
}

In the example embodiment of FIGS. 4 and 5, the tile header 270 includes metadata fields such as an aggregate number of shares in the tile and number of open orders in the tile, as well as four doubly linked lists: a free list and a total of three doubly linked priority lists 350 (P0, P1 and P2). A tile header 270 may also include items such as a type, list head 370 and list tail 380 identifiers for priority lists and free list, and the tile's associated symbol, price, and side. (Note that, for simplicity, details of the fields of the tile header 270 are not shown in FIG. 5 as such details are shown in FIG. 4 and in the discussion above; it should be understood, however, that in the embodiment of FIGS. 4 and 5, the tile header 270 in FIG. 5 may include the same fields as the tile header 270 shown in FIG. 4).

The tile header 270 is followed by a tile body portion 280 that includes an array 290 of access node 260 objects (or the “an_array” shown above). In the embodiments shown in FIG. 4 and FIG. 5, a tile 250 may store a predetermined maximum number of access nodes 260 in the array 290, such as 256. It should be noted, however, that a tile 250 may also store other predetermined numbers of access nodes, such as 128, 512, or 1024.

Read access times for fetching data from an SDRAM tend to be relatively slow on initial access, but become more efficient with sequential access. Therefore, when the underlying memory technology is SDRAM or some other dynamic memory, storing all access nodes associated with a given Instrument, Side and Price in the same tile 250 enables fetching the entire tile in a single sequential access, thus optimizing the ability quickly and efficiently fetch many related orders as a group.

In some embodiments, although a tile's capacity (i.e., maximum number of access nodes in the “an_array” or access node array 290 of the tile) may be fixed, different tiles 250 may have different fixed capacities, such as 256, 512 or 1024 access nodes 260. Thus, if the number of active open orders for a given ISP exceeds the capacity of their associated tile, the access nodes may be moved to a tile with a larger capacity. Optionally, when access nodes for an ISP exceed the capacity of their tile and need to be promoted to a larger tile, the original tile may function effectively as a pointer to the larger tile, such that the original tile contains a memory address (i.e., “indirect_address” field of the tile in this example) of the larger tile at another location in external memory. This indirect address mode may be indicated in the type field of the tile header 270, while the “indirect address” field may in some embodiments be stored as a field in the tile body portion 280.

As discussed above, each access node 260 within a tile 250 may be identified by its access node index 265. In the embodiment of FIG. 3, the access node index 265 may correspond to an index of the access node 260 within the tile's access node array 290. Other indexing schemes may be used. For example, in other embodiments, the access node index 265 may correspond to a byte offset of the access node 260 within the access node array 290 or a byte offset of the access node 260 within the tile 250. Thus, according to these embodiments, the access node indices 265 are therefore local or relative to a particular tile.

References (also referred to as, “pointers”) to access nodes 260 in a tile 250 within the tile's doubly linked priority lists 350 and free list 360 discussed above may also be via access node indices 265, and consequently, may also be local or relative to that tile.

Access nodes 260 representing corresponding cells 210 can be added to one of the priority lists in a tile 250. Access nodes 260 on higher priority lists such as list 350-0 preferably have their respective orders executed before open orders of access nodes 260 on lower priority lists such as list 350-1. Within each of the priority lists, access nodes 260 at or near the top of a list 350 have their respective orders executed before those of access nodes 260 at or near the bottom of the list. In the illustrated embodiment, the priority lists 350 are implemented as linked lists. Accordingly, an access node 260 can include pointers (or references) for internally linking the access node to one of the priority lists 350. For example, as shown, an access node 260 can include one pointer N to the next access node in the list 350-1 (e.g., next pointer) and another pointer P to the previous access node in the same list 350-1.

The tile 250's priority lists 350 may be organized based on one or more attributes of the access nodes 260 to provide trade execution preference based on order modality. For example, resting “displayed” orders are typically filled before “hidden” ones. In one embodiment there is a first priority list 350-1 for displayed orders, another priority list 350-2 for hidden orders, and one or more additional priority lists, such as priority list 350-3, to support arbitrary prioritization functionality. When a large order is filled, the higher priority list of (for example, displayed) orders may be executed before orders on the next level priority list. Within a given priority list, orders may be arranged and filled in a variety of ways. For example, orders may be sorted according to First-In-First-Out (FIFO) order to support time arrival order preference. Orders may alternatively be sorted on a priority list according to sequence, such as the GSEQ identifier stored within each access node 260. In other implementations, priority may be determined by the size of the order (e.g., the quantity of shares or the value of the order), or priority may be determined by the identity of an entity associated with the order, or in other ways.

In some embodiments, the priority of an order may be a field specified in the cell 210 that may be assigned by one or more other components of the system 100, such as the gateway 110. Additionally, or alternatively, the priority may be determined in the MEB 150 according to characteristics of the order.

The tile 250's free list 360 may be a linked list of unused or “empty” access node 260 data structures in the access node array 290. At the start, the data in the access nodes 260 on this free list 360 are empty except for pointers. When a new access node 260 needs to be associated with a cell 210 for a new resting order, a next free access node 260 is moved to one of the active priority lists 350. This “move” may not require rewriting, copying, or moving the data in the access node 260, but simply adjusting and/or rewriting the references (e.g., next reference and/or previous reference) relating to that access node 260 within the tile's linked lists.

Organizing the access nodes 260 into one or more prioritized lists 350 and free list 360 which are included in the tile 250 along with the access node array 290 enables quick access to all relevant data for matching a trade of a next open order having the same ISP once its associated tile is loaded in the on-chip FPGA Block RAM 230. As a result, no additional external memory accesses are needed to process a set of open orders having the same ISP, given that the relevant information needed to match those open orders has effectively already been prefetched.

While the priority lists 350 and free list 360 are described in the embodiment of FIGS. 3 and 5 above as being implemented as doubly linked lists, other suitable prioritized collections of access nodes may alternatively or additionally be employed to organize access nodes within a tile, such as other forms of list, tree, array, or graph data structures. For example, singly linked lists may be employed in which each access node includes a reference to a next access node in the list, without also including a reference to a previous access node in the list. In embodiments in which a tile includes multiple prioritized collections, different prioritized collections within the same tile may be implemented using different data structures, for example, according to the expected access pattern of each prioritized collection.

Furthermore, the one or more head and/or tail references associated with a prioritized collection (or linked list, in the embodiment of FIGS. 3, 4 and 5) may be more generally considered as one or more insertion point references and/or removal point references. In some embodiments, it may be desirable to insert an access node at a particular point in a prioritized collection using an insertion point reference, and/or to remove an access node from the prioritized collection 350 at a different particular point using a removal point reference. In the embodiment of FIGS. 3, 4 and 5, access nodes may be removed from a priority list and/or free list using a head reference, and inserted into a priority list and/or free list using a tail reference; however, other embodiments may be implemented with the reverse approach (i.e., to insert an access node using the head reference, and to remove an access node using the tail reference). Yet other embodiments may, at least in some scenarios, remove and/or insert an access node at other points in the prioritized collection, for example, at a midpoint in a linked list, or some intermediary position in the prioritized collection.

Cache Manager Interface 225 Between Book Processing Logic 220 and Access Node Cache 160

As shown in FIG. 2, in some embodiments, the cache manager 225 provides an interface between the Book Processing Logic (BPL 220) and the cache 160. It may maintain the access nodes 260 in memory and provides the following example operations:
[AN] get_next_an(ISP)—return next access node 260 on highest priority list
[AN] get_an(ISP, AN-Idx)—return access node 260 at specified access node index 265

Both of these operations allow the BPL 220 to request and receive an access node 260 with a given instrument, side and price (ISP) from the cache 160. According to some embodiments, in response to either of these operations, the cache manager 225 may be responsible for quickly locating, for example, by means of the symbol registry 270, the base address in external memory of the tile 250 based on attributes such as symbol, side, and price. It should be understood that, in general, an address used by the processor for these operations may include either an off-chip DRAM address or an on-chip Block RAM, or both, depending on where the access node is located. Once the base address of the tile 250 in the appropriate memory has been determined, the tile 250 associated with the provided ISP can then be fetched by the cache manager 225 from the appropriate memory (e.g., external memory such as DRAM 240) and, in some embodiments, stored in relatively faster memory, such as the onboard FPGA Block Ram LO Cache 230.

### Tile Relocatability

As should be apparent from the discussion above related to the tile 250, all elements of a tile 250, including its access node array 290, self-contained linked lists 350, 360 and tile-relative access node index 265, allow the tile 250 to be “memory position agnostic” and therefore, relocatable. Accordingly, all of a tile 250's data (including its access nodes) may be accessed and its linked lists traversed without a need for modifying the tile 250, even if the tile 250 was moved to a different memory location (e.g., from external DRAM 240 to FPGA Block Ram 230 or even a different location in the DRAM 240). Thus, according to some embodiments, including those discussed below, accesses to a tile 250 while performing match related processing may be made in faster FPGA Block RAM 230.

More details regarding the get_next_an and get_an operations performed by cache manager 225 according to some embodiments are provided below.

get_next_an

After fetching into FPGA Block RAM 230 the relevant tile 250 corresponding to the provided ISP, the cache manager 225 may return to the BPL 220 the next access node 260 in the tile 250 according to proper priority order. That is, in some embodiments, the cache manager 225 may return the access node 260 at the head of the current highest non-empty priority list in the associated tile 250.

The BPL 220 may thus call get_next_an repeatedly on the same ISP in the processing of a large Fill in which a contra order with a large quantity is matched against multiple resting orders having relatively smaller quantities. Subsequent calls to get_next_an for the same ISP may traverse the priority lists 350 in FIFO order, according to some embodiments, moving on to the next highest priority list 350 when all the access nodes have already been processed from the current priority list. Because all of the access nodes for a given ISP are stored in the fast FPGA block RAM, the get_next_an request can be processed as quickly as possible, without the need to fetch data from the external DRAM.

According to some embodiments, when all the access nodes 260 for a particular ISP have been processed, get_next_an, when called on that same ISP, may cause the cache manager 225 to move to the next price level (that is, fetch from DRAM to FPGA Block Ram a next tile 250 for the same symbol and side, but at the next price), and traverse the priority lists in the new tile 250 in the same manner as discussed above. The tile 250 structure thus frees the BPL 220 from having to be aware of or implement logic to determine the “next order” in a sequence of orders. The access nodes 260 will already be organized in one or more linked lists according to the desired priority of execution.

get_an

In contrast to get_next_an, which returns an access node 260 from the fetched tile 250 at the provided ISP by traversing the priority lists, get_an instead returns a specific access node 260 (also within the fetched tile 250 at the provided ISP) at the provided access node index 265. Rather than traversing the priority lists, the cache manager 225 may thus instead index into the access node array 290 to return a specific access node 260 at that provided access node index 265. This situation may be most commonly encountered when the BPL 220 is processing a cancel request on an existing resting order, as such resting orders may already be associated with an access node index 265 stored in the corresponding cell 210.

### Prefetching and Other Optimizations

Some embodiments may implement one or more of the optimizations detailed below.

Prefetching for get_next_an Optimization

In some embodiments, get_next_an may be expected to traverse multiple price levels “automatically,”. Therefore, the cache manager 225 may optionally perform a form of prefetching tiles 250. According to this embodiment, when get_next_an is called for a requested ISP, the cache manager 225 may prefetch into FPGA Block RAM the tile(s) 250 with finite orders for one or more subsequent price levels, even while the access nodes 260 in a first tile 250 at the requested ISP are still being processed by the BPL 220. This may ensure that the Block RAM 230 has the access node 260 for the next best price already available, even before it is requested by the BPL 220.

get_next_an Optimization

In response to a get_next_an request from the BPL 220, the cache manager 225 may provide to the BPL 220 a next access node 260 even before the tile 250 containing that access node 260 is completely loaded in the FPGA Block RAM 230. When servicing a get_next_an request from the BPL 220, the cache manager 225 may first need to load the tile 250 associated with the provided ISP into FPGA Block RAM 230. It should be appreciated however, as soon as the tile header 270 is loaded in FPGA Block RAM 230, the access node index 265 for the access node 260 at the head of the highest priority list is already known. Accordingly, as soon as the access node 260 at that access node index 265 of the access node array 290 has been loaded into FPGA Block RAM 230, the cache manager 225 may provide the appropriate access node 260 to the BPL 220 even before the entire tile 250 has been loaded.

### Free List Optimization

The free list 360 may also be optimized in some embodiments to exploit the typical situation (as discussed above in connection with the get_next_an optimization) in which the access nodes in the tile 250 access node array 290 are loaded sequentially into FPGA Block RAM 230. As is the case for the access nodes within the priority lists 350, the access nodes within the free list 360 may be accessed via an index into the access node array. In such embodiments, it is preferable to use access nodes 260 with lower access node index 265 values. Accordingly, when access nodes 260 are removed from one of the priority lists 350 to the free list 360, the process may not push the access node 260 to the end of the free list 360. Instead, in some embodiments, the access node 260 may be pushed on to the free list 360 such that access nodes 260 having lower access node index 265 values are popped first from the free list 360, regardless of the order of their freeing. This may make it more likely that access nodes 260 being requested have lower access node index 265 values and are therefore made available in FPGA Block RAM 230 earlier. In some embodiments, for example, access nodes 260 may be added to the freelist 360 in order sorted by their access node index 265 values. This optimization may be implemented, for example with a bitmask, bit field, bit vector, or memory lookup table, that includes one bit for each access node 260 in the tile 250, where the bits are set to true when the associated access node index 265 is free.

In other embodiments, when an access node 260 is freed from a priority list 350, the cache manager 225 may compare the value of the access node 260's access node index 265 (into the access node array 290) to a threshold value (which may be predetermined, configurable, or dynamically determined based on characteristics of the system). In such embodiments, when the access node index 265 value for the access node 260 being freed is less than or equal to that threshold value, the access node 260 may be pushed onto the head of the freelist 360. On the other hand, when the access node index 265 value is greater than the threshold value, the access node 260 may be pushed to the tail of the freelist 360. Such embodiments may tend to prioritize access nodes 260 with low access node 265 values over access nodes 260 with high access node 265 values when popping new access nodes 260 from the head of the freelist 350.

As an additional optimization in some embodiments, the cache manager 225 may periodically reindex the free list 360 of access nodes 260 in a tile 250 (for example, as a background process) in order to ensure that their access node index 265 values remain as much as possible in numerical order.

get_an Optimization

It may also be possible for the BPL 220 to begin processing an access node 260 before the entire associated tile 250 has been loaded in FPGA Block RAM 230. This may be advantageous in situations in which the BPL 220 issues a get_an operation to request an access node 260 at a specific access node index 265. In such situations, the cache manager 225 may determine the appropriate offset within the tile 250 at which the access node 260 with the requested access node index 265 may be located within the tile's 250 access node array 290, and may begin loading the tile at that offset, thereby quickly returning to the BPL 220 the requested access node 260 prior to the entire tile's having been loaded in FPGA Block RAM 230. In other words, at least one access node may be accessible for processing by the BPL 220 before the entire tile is loaded into FPGA Block RAM 230.

### Method of Processing Request for Access Node

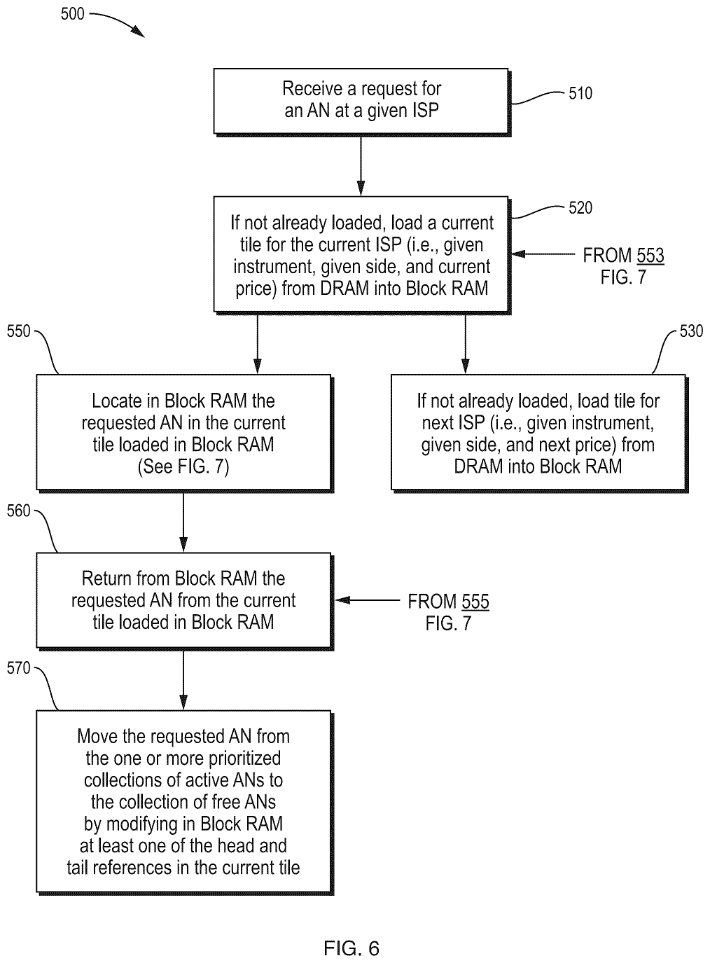

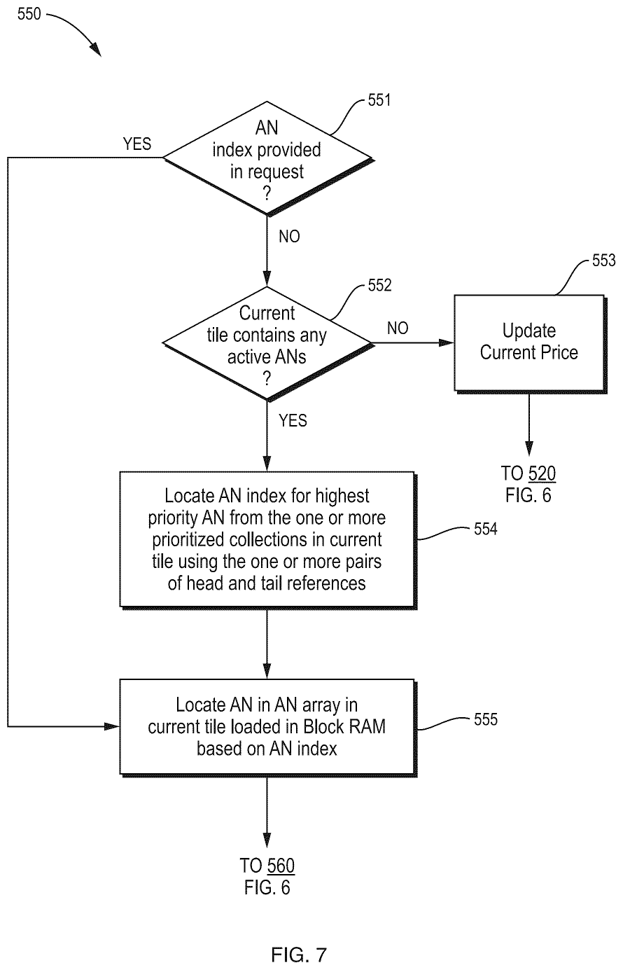

FIGS. 6 and 7 are flow diagrams that illustrate a method 500 according to some embodiments of the cache manager 225 for processing a request for an access node. Method 500 may be implemented by the cache manager 225, described above in connection with FIGS. 1 and 2.

At block 510, cache manager 225 receives a request for an access node 260 (AN) at a given instrument, side, and price (ISP). This request may originate from the Book Processing Logic (BPL) 220 or from a ticker plant 140, for non-limiting example, and may be received over an interface. The request may for example be via the get_an or get_next_an interface, as discussed above.

At block 520, cache manager 225 determines whether a current tile 250 for the current ISP (i.e., the given instrument, given side, and a current price) has been prefetched and is already loaded in FPGA Block RAM 230. When it has been determined that the current tile 250 has not been prefetched in FPGA Block RAM 230, a tile 250 for the current ISP is loaded from DRAM 240 into onboard FPGA Block RAM 230. In some embodiments, the cache manager 225 may keep track of the “current price,” which may be the price closest to the given price for the given instrument and given side at which there are active open orders, and accordingly, active access nodes stored in the cache 160. The “current tile” in such embodiments may correspond to the tile for the given instrument, given side, and the current price. The current price may differ from the given price in the request, for example, if there are no active access nodes in the cache 160 at the given price.

As discussed above in connection with the prefetching optimization, in some embodiments, cache 160 may typically have already loaded in FPGA Block RAM 230 the tile for the current ISP prior to receiving a request for an AN for the current ISP.

In some embodiments, execution may then proceed in parallel to block 550 (discussed further below) and block 530.

At block 530, in some embodiments, the cache manager 225 determines whether a tile 250 for the next ISP (i.e., given instrument, given side, and a next closest price to the current price) has already been loaded in FPGA Block RAM 230. When it has been determined that the tile 250 for the next ISP has not already been loaded in Block RAM, the tile 250 for the next ISP may be prefetched from DRAM 240 into FPGA Block RAM 230. In some embodiments, the cache manager 225 may track (for example, via a bit field or memory lookup table) which tiles 250 contain active access nodes 260, such that the next closest price may be the next closest price to the current price that has active access nodes 260. This prefetching operation of the next tile 250 ensures that a tile for the next closest price is already in FPGA Block RAM 230 before that tile 250 may be needed to satisfy any requests for access nodes.

At block 550, (which, in some embodiments, may be performed in parallel with the step at block 530), cache manager 225 locates in FPGA Block RAM 230 the requested access node 260 in the current tile 250 already loaded in FPGA Block RAM 230. This step at block 550 may entail different scenarios depending on the nature of the request and the specific contents of the current tile. Further details of the step of block 550 according to some embodiments are shown in FIG. 7.

At block 560, cache manager 225 returns from FPGA Block RAM 230 the requested access node 260 from the tile 250 for the current ISP. This step may involve copying the data content of the access node from FPGA Block RAM 230 to memory accessible to the component (e.g., BPL 220 or a ticket plant 140) that initiated the request.

At block 570, the cache manager 225 frees the requested access node 260 in the current tile 250, thereby making the access node memory available to be used for other orders. In some embodiments, this may involve moving the requested access node 260 from a prioritized collection of access nodes (e.g., one of the priority lists 350) in the tile 250 to the tile's collection of free access nodes (e.g., the free list 360), by modifying in FPGA Block RAM 230 at least one of the head and tail references in the current tile loaded in FPGA Block RAM 230. For example, if this step requires the access node 260 to be removed from the head of a priority list 350 in the tile 250 and placed onto the tail of the tile's free list, this step may involve modifying in FPGA Block RAM 230 the value of the head reference 370 of the priority list to be set to the value of a different access node index in the current tile 250, and also modifying in FPGA Block RAM 230 the value of the tail reference 380 of the free list 360 to be set to the value of the access node index of the access node being returned. In some embodiments, the step at block 570 may be performed prior to the step at block 560.

FIG. 7 illustrates details of the step at block 550 of method 500 in FIG. 6, namely the process of locating the requested access node 260 in the current tile 250. The cache manager 225 may locate the requested access node 260 differently based on the nature of the request. At block 551, the method determines whether the request provided an access node index IDX, such as may be provided using the “get_an” interface, discussed above. An access node request may typically provide an access node index when the specific access node is already known to the requestor, for example, as part of a request to cancel an existing resting order.

When an access node index IDX is provided in the request, the method proceeds to block 555. At block 555, cache manager 225 locates, based on the access node index (IDX), an access node 260 in the access node array of the current tile 250 loaded in Block RAM. The access node index IDX may serve as the basis for calculating an offset of the requested access node 260 in the access node array 290.

On the other hand, some access node requests may not provide an access node index, for example when using the “get_next_an” interface, discussed above. Such access node requests may typically be issued as part of satisfying a match or fill with a new contra-side order in which the cache manager 225 is being requested to return a next access node 260 at a given ISP. In such scenarios, the cache manager 225 may proceed to block 552, in which it determines whether the current tile 250 contains any active access nodes 260, that is, access nodes associated with open resting orders. As part of matching or filling a large new contra-side order (which may involve performing multiple partial matches with multiple existing resting orders), the “get_next_an” interface may be called repeatedly for the same ISP, in which case the cache manager 225 may have already returned to the requestor (in prior requests) all the active access nodes 260 from the current tile 250. In some embodiments, determining whether a tile contains any active access nodes 260 may be accomplished by checking the value of one or more fields in the tile header 310, such as the number of open orders in the tile 250 or the quantity of open shares for the tile 250.

When it is determined that the current tile 250 contains no active access nodes 260, at block 553, the cache manager 225 updates the current price. In some embodiments, this may involve updating the current price to the next closest price at which the associated tile contains active access nodes. The execution may then return to block 520 in FIG. 6.

On the other hand, when it is determined that the current tile contains one or more active access nodes, the method 500 proceeds to block 554. At block 554, the cache manager 225 locates an access node index IDX for a highest priority access node 260 in the one or more prioritized collections of access nodes 260 in the current tile loaded in FPGA Block RAM 230, using the one or more pairs of head 370 and tail 380 references associated with the one or more prioritized collections. In some embodiments, including the embodiment of method 500, the head 370 and tail 380 references may be access node index values, which may then be used to locate an access node in the access node array 290, as discussed in connection with block 555.

In embodiments in which a tile 250 comprises multiple prioritized collections 350, the cache manager 225 may attempt to locate an access node 260 in a prioritized collection 350 having a highest priority before moving to a prioritized collection 350 having a next highest priority, generally proceeding through the prioritized collections 350 in order of highest to lowest priority. In some embodiments, each prioritized collection 350 may also be sorted. For example, if the prioritized collections 350 are implemented as linked lists, a next highest priority access node 260 may be located from the head of each respective list 350 by following the head reference 370 for the list in the current tile.

Once an access node index IDX for the highest priority access node 260 has been located, the method proceeds to block 555, in which, as discussed above, the cache manager 225 locates an access node 260 in the access node array 290 of the current tile 250, based on the access node index IDX. The method then proceeds to block 560 in FIG. 6.

As discussed above in connection with FIG. 1, an electronic trading system 100 may include a ticker plant 140. In particular, a ticker plant 140 can be used by various participant devices to access market data in real-time. Ticker plants often mirror the real-time market data managed by a matching engine book 150. Although the foregoing primarily describes systems and methods for minimizing the need to access external memory from a matching engine book (MEB) 150, such systems and methods may also be incorporated into a ticker plant 140.

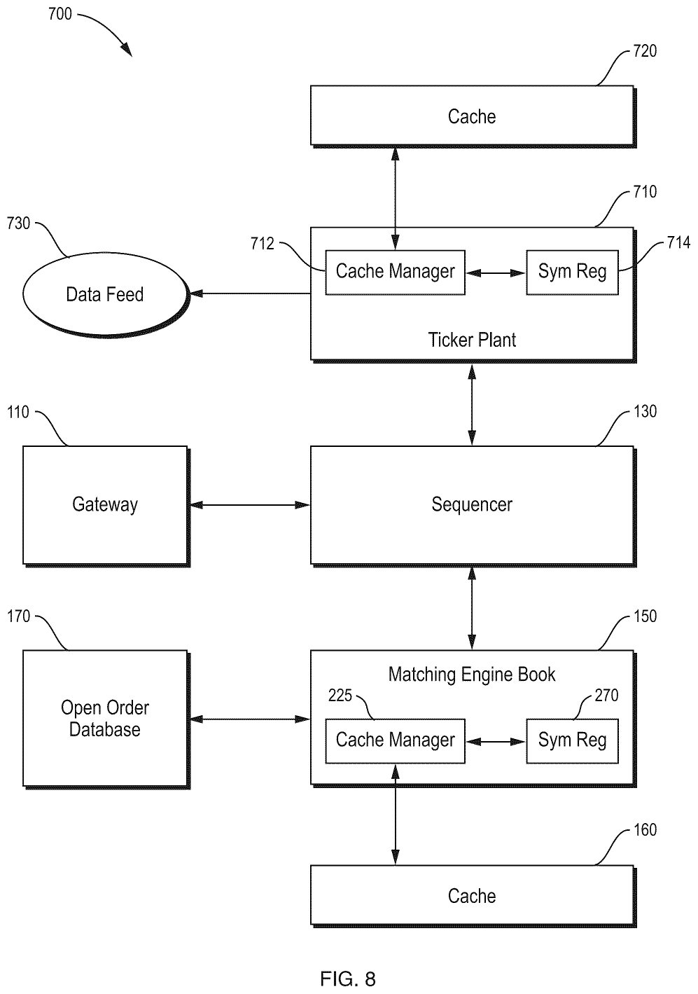

FIG. 8 is a schematic diagram that illustrates such an embodiment of an automated trading system 700, including a ticker plant 710 that maintains a separate order book in the form of a memory cache 720. The gateway 110, the sequencer 130, the open order database 170, the matching engine book 150, the Book Processing Logic (BPL) 220, the cache manager 225 and the symbol registry 270 contained therein, and the cache 160 are as previously described above. For purposes of brevity, a description of these components is omitted.

As shown in FIG. 8, the ticker plant 710 includes its own cache manager 712 and symbol registry 714 for managing and accessing tiles in its own cache 720. The ticker plant 710, which also includes an internal memory cache (not shown), may be implemented in fixed hardware logic, such as an FPGA or and ASIC. The structure and operation of the cache manager 712, the symbol registry 714, and the cache 720 can be substantially the same, if not identical to, the structure and operation of the cache manager 225, the symbol registry 270, and the cache 160 of the matching engine book 150 as described above.

In order to maintain the current state of the order book in the external cache 160, the fixed logic of the ticker plant 140 may be configured to passively monitor acknowledgment messages to various trading events from the matching engine book 150, including but not limited to acknowledgments to requests to open buy or sell orders, acknowledgments to requests to cancel an order, acknowledgements to requests to replace an order, or acknowledgements to requests to modify an order. The ticker plant 140 may also passively monitor messages indicating that particular orders are filled. In the illustrated embodiment, such messages may be routed directly to the cache manager 712 of the ticker plant 710 through the sequencer 130.

Using these messages, the fixed logic of the ticker plant 710 can make requests to the cache manager 712 to modify tiles within the cache 720 by adding, removing, or modifying tiles containing open order data (e.g., as stored in the access nodes) that represent open orders for given instrument, side, and price tuples. In this way, the cache manager 712 of the ticker plant 710 may maintain an up-to-date order book in the cache 720 that mirrors the order book maintained in the cache 160 of the matching engine book (MEB) 150.

To respond to market data feed requests from participant devices, the fixed logic of the ticker plant 710 can request open order data (e.g., an access node 260) from the cache manager 712 for a particular instrument, side, and price. The cache manager 712, in turn, can fetch a tile from its own cache 720 as described above and load the tile into an internal memory cache of the cache manager 712 or of the cache 720. Once loaded, the cache manager 712 can read the requested open order data from the tile and return the data to the requesting logic of the ticker plant 710 for further processing as content of the responsive data feed 730.

In some embodiments, the cache manager 712 of the ticker plant 710 may be configured to receive requests for all information about a given instrument, side and price. Alternatively or additionally, the cache manager 712 of the ticker plant 710 may be configured to receive requests for specific information regarding a given instrument, side, and price, including but not limited to the number of open orders or quantity or the total open order quantity (e.g., number of open shares) at a given instrument, side and price. In some embodiments, the cache manager 712 may be configured to respond to requests for information, including without limitation the best bid and ask price for a given instrument, that may be provided from the symbol registry 714 or other internal information source.

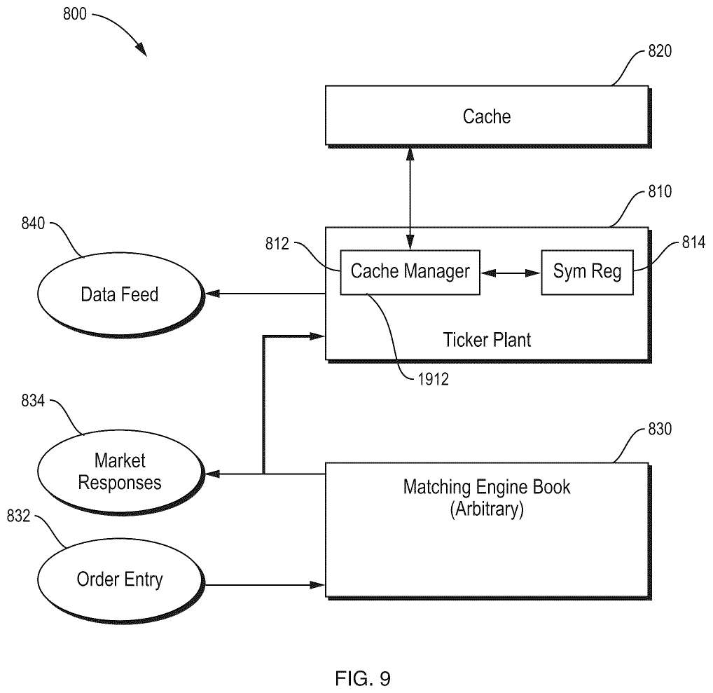

FIG. 9 is a schematic diagram that illustrates another embodiment of an automated trading system 800, including a ticker plant 810 that maintains a separate order book in its own cache 820. In the illustrated embodiment, the ticker plant 810 includes cache manager 812 and a symbol registry 814 for managing and accessing tiles in cache 820. The structure and operation of the cache manager 812, the symbol registry 814, and the cache 820 is substantially the same as the structure and operation of the cache manager 712, the symbol registry 714, and the cache 720 of the ticker plant 710 as described above in connection with FIG. 8.

However, in the illustrated embodiment of FIG. 9, the ticker plant 810 is configured to maintain the order book in the cache 820 based on market responses 834 transmitted to participant devices (120 of FIG. 1) over a network. In particular, the matching engine book (MEB) server 830 can be any arbitrary MEB server that is capable of receiving order entries 832 and outputting various market responses 834 to participant devices, including the MEB server 150 described above.

Thus, in order to maintain the current state of the order book in the external cache 820, the fixed logic of the ticker plant 810 may subscribe to and passively monitor market responses 834 to various trading events from the matching engine book 830, including but not limited to acknowledgments to requests to open buy or sell orders, acknowledgments to requests to cancel an order, acknowledgements to requests to replace an order, or acknowledgements to requests to modify an order as well as messages indicating that particular orders are filled. Such market responses 834 may be received by the ticker plant 810 over any type of external network, including public and private networks.

Using these messages, the fixed logic of the ticker plant 810 can make requests to the cache manager 812 to modify tiles within the external multi-level memory cache 820 by adding, removing, or modifying tiles containing open order data (e.g., access nodes 260) that represent open orders for given instrument, side, and price tuples. In this way, the cache manager 812 of the ticker plant 810 may maintain an up-to-date order book in the external multi-level memory cache 820 that mirrors the order book maintained by the arbitrary matching engine book (MEB) server 830. As discussed above, the logic of the ticker plant 800 can request open order data or other market data from the cache manager 812 in response to market data feed requests from participant devices for a particular instrument, side, and price.

### Implementation Options

Although the above discussion has been primarily in the context of a Matching Engine Book (MEB) and a data feed service or ticker plant, it should be understood that the same design features may be applied to other components of a matching engine system or other types of high performance processors. These features can thus be advantageous for other types of “matching” applications—search engines, image recognition, database engines, and the like—especially where the data is ordered in some determined sequence.

Furthermore, the memory resources and processing resources needed to implement the functions described may be implemented as one or more special-purpose processors or general-purpose processors that are arranged to perform the functions detailed herein. Such special-purpose processors may be Application Specific Integrated Circuits (ASIC)s or Field Programmable Gate Arrays (FPGA)s which are general-purpose components that are physically and electrically configured to perform the functions detailed herein. Such general-purpose processors may execute special-purpose software or microcode that is stored using one or more memory resources such as non-transitory processor-readable mediums, including random access memory (RAM), flash memory, or a solid state drive (SSD).

More generally, the methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may execute the program code to perform the tasks described.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered.

The above description has therefore particularly shown and described example embodiments. However, it will be understood by those skilled in the art that various changes in form and details may be made therein without departing from the legal scope of this patent as encompassed by the appended claims.

### Further Implementation Options

It should be understood that the workflow of the example embodiments described above may be implemented in many different ways. In some instances, the various “data processors” may each be implemented by a physical or virtual or cloud-based general purpose computer having a central processor, memory, disk or other mass storage, communication interface(s), input/output (I/O) device(s), and other peripherals. The general-purpose computer is transformed into the processors and executes the processes described above, for example, by loading software instructions into the processor, and then causing execution of the instructions to carry out the functions described.

As is known in the art, such a computer may contain a system bus, where a bus is a set of hardware lines used for data transfer among the components of a computer or processing system. The bus or busses are essentially shared conduit(s) that connect different elements of the computer system (e.g., one or more central processing units, disks, various memories, input/output ports, network ports, etc.) that enables the transfer of information between the elements. One or more central processor units are attached to the system bus and provide for the execution of computer instructions. Also attached to system bus are typically I/O device interfaces for connecting the disks, memories, and various input and output devices. Network interface(s) allow connections to various other devices attached to a network. One or more memories provide volatile and/or non-volatile storage for computer software instructions and data used to implement an embodiment. Disks or other mass storage provides non-volatile storage for computer software instructions and data used to implement, for example, the various procedures described herein.

Embodiments may therefore typically be implemented in hardware, custom designed semiconductor logic, Application Specific Integrated Circuits (ASICs), Field Programmable Gate Arrays (FPGAs), firmware, software, or any combination thereof.

In certain embodiments, the procedures, devices, and processes described herein are a computer program product, including a computer readable medium (e.g., a removable storage medium such as one or more DVD-ROM's, CD-ROM's, diskettes, tapes, etc.) that provides at least a portion of the software instructions for the system. Such a computer program product can be installed by any suitable software installation procedure, as is well known in the art. In another embodiment, at least a portion of the software instructions may also be downloaded over a cable, communication and/or wireless connection.

Embodiments may also be implemented as instructions stored on a non-transient machine-readable medium, which may be read and executed by one or more procedures. A non-transient machine-readable medium may include any mechanism for storing or transmitting information in a form readable by a machine (e.g., a computing device). For example, a non-transient machine-readable medium may include read only memory (ROM); random access memory (RAM); storage including magnetic disk storage media; optical storage media; flash memory devices; and others.

Furthermore, firmware, software, routines, or instructions may be described herein as performing certain actions and/or functions. However, it should be appreciated that such descriptions contained herein are merely for convenience and that such actions in fact result from computing devices, processors, controllers, or other devices executing the firmware, software, routines, instructions, etc.

It also should be understood that the block and system diagrams may include more or fewer elements, be arranged differently, or be represented differently. But it further should be understood that certain implementations may dictate the block and network diagrams and the number of block and network diagrams illustrating the execution of the embodiments be implemented in a particular way.

Embodiments may also leverage cloud data processing services such as Amazon Web Services, Google Cloud Platform, and similar tools.

Accordingly, further embodiments may also be implemented in a variety of computer architectures, physical, virtual, cloud computers, and/or some combination thereof, and thus the computer systems described herein are intended for purposes of illustration only and not as a limitation of the embodiments.

The above description has particularly shown and described example embodiments. However, it will be understood by those skilled in the art that various changes in form and details may be made therein without departing from the legal scope of this patent as encompassed by the appended claims.

1. An electronic data processing system comprising:
a data processor configured to perform one or more market functions;
a memory, accessed by the data processor to configure data stored therein as one or more tiles, with each tile further comprising:
an array of access nodes that represent open orders for a given instrument, side, and price;
metadata fields that relate to the array of access nodes; and
one or more head and/or tail references that organize the array of access nodes into one or more prioritized collections of active and/or free access nodes.

2. The system of claim 1 wherein the access nodes further contain references to cell data structures that contain additional data that represent the orders.

3. The system of claim 1 wherein the one or more prioritized collections are sorted based on one or more attributes of the access nodes in the array of access nodes, the one or more attributes including at least a sequence, a time received, or a quantity.

4. The system of claim 1 wherein the one or more prioritized collections are each implemented as a linked list, with each linked list further comprising selected ones of the head and tail references, and each access node in the array including a reference to a next access node or a previous access node in the linked list.

5. The system of claim 1 wherein the one or more prioritized collections are each implemented as a doubly linked list, with each doubly linked list comprising selected ones of the the head and tail references and each access node in the array including both a reference to a next access node and a reference to a previous access node.

6. The system of claim 1 additionally wherein:
the memory includes on-chip Block Random Access Memory (Block RAM) located on a semiconductor chip with the processor;
the memory also includes off-chip Dynamic Random Access Memory (DRAM) that is not located on the semiconductor chip with the processor; and
two or more tiles are stored contiguously such that they are accessible by a single address parameter.

7. The system of claim 6 wherein a source address and destination address for the processor to access the memory include one or more of an off-chip DRAM address or an on-chip Block RAM address.

8. The system of claim 1 wherein the one or more tiles further comprise a predetermined number of access nodes and a selected tile contains a reference to another one of the tiles, such that a total number of access nodes for a given instrument, side and price extends beyond the predetermined number of access nodes.

9. The system of claim 1 wherein at least one access node contained within a selected tile is accessible to the processor before an entire transfer of the selected tile is complete.

10. The system of claim 1 wherein the one or more tiles further comprise a free list maintained in order by index into the array of access nodes.

11. The system of claim 5 wherein at least one of the tiles is configured to enable the processor to move an access node between two of the prioritized collections by rewriting the reference to the previous access node and the reference to the next access node.

12. The system of claim 2 wherein the cell data structures include static order data stored in a data structure that is separate from the one or more tiles.

13. The system of claim 12 wherein the cell data structures each include fields indicating an instrument, side, price, and an access node index associated with the cell, and wherein the processor is enabled to use the instrument, side, price, and access node index to locate an associated access node within at least one of the tiles.

14. The system of claim 1 wherein each access node contains a reference to a corresponding one of the cell data structures.

15. The system of claim 1 wherein the one or more market functions comprise one or more matching engine books.

16. The system of claim 1 wherein the one or more market functions comprise one or more market data feeds.

17. The system of claim 1, wherein the processor is implemented using fixed logic, and the fixed logic comprises any of a field programmable gate array (FPGA) and application specific integrated circuit (ASIC) or other embedded hardware technologies.

18. A computer program product in a computer-readable medium for use in a data processing system for executing a market function, the computer program product comprising:
first instructions for receiving access nodes, each access node referencing a cell data structure representing order data associated with an instrument, side and price;
second instructions for inserting the access nodes into one or more tiles, each of the one or more tiles comprising:
an array of the access nodes for a given instrument, side, and price;
metadata fields that relate to additional order data for the given instrument, side, and price; and
at least a head and a tail reference organizing the access nodes in the array into one or more prioritized collections; and
third instructions for processing the array of access nodes to execute the market function.

19. An electronic data processing system comprising:
one or more data processors; and
one or more memories, accessed by the one or more data processors to configure data stored therein as one or more tiles, the one or more memories comprising:
an on-chip Block Random Access Memory (Block RAM) located on a semiconductor chip with the at least one of the one or more data processors; and
an off-chip Dynamic Random Access Memory (DRAM);
wherein each of the one or more tiles comprises:
an array of access nodes that represent orders for a particular instrument, side and price (ISP); and
one or more head and/or tail references that organize the access nodes into one or more prioritized collections of active access nodes and a collection of free access nodes; and
wherein the one or more data processors are further configured for:
receiving a request for an access node at a given ISP;
loading a tile for the given ISP from the DRAM into the Block RAM;
locating in the Block RAM the requested access node in the tile for the given ISP loaded in the Block RAM; and
returning from the Block RAM the requested access node from the tile for the given ISP loaded in the Block RAM.

20. The system of claim 19, wherein the one or more data processors are further configured for:
moving the requested access node from the one or more prioritized collections of active access nodes to the collection of free access nodes, the moving comprising modifying in the Block RAM at least one reference in the one or more head and/or tail references.

21. The system of claim 20, wherein:
the request for an access node at a given ISP comprises a first request for a first access node at the given ISP, the first request being associated with a new order; and
locating in the Block RAM the requested access node in the tile for the given ISP further comprises locating in the Block RAM in a first prioritized collection of the one or more prioritized collections the first access node via the one or more head and/or tail references.

22. The system of claim 21, wherein the one or more data processors are further configured for:
receiving a second request for a second access node at the given ISP, the second request being associated with the new order;
locating in the Block RAM the requested second access node in the tile for the given ISP, the locating further comprising locating in the Block RAM in the first prioritized collection the second access node via the one or more head and/or tail references; and
returning from the Block RAM the second requested access node from the tile for the given ISP loaded in the Block RAM.

23. The system of claim 21, wherein the one or more data processors are further configured for:
receiving a second request for a second access node at the given ISP, the second request being associated with the new order;
locating in the Block RAM the requested second access node in the tile for the given ISP, the locating further comprising locating in the Block RAM in a second prioritized collection the second access node via the one or more head and/or tail references; and
returning from the Block RAM the second requested access node from the tile for the given ISP loaded in the Block RAM.

24. The system of claim 21, wherein:
the given ISP comprises a given instrument, a given side, and a first price;
the tile at the given ISP comprises a first tile; and
the one or more data processors are further configured for:
receiving a second request for a second access node at the given ISP, the second request being associated with the new order;
loading a second tile from the DRAM into the Block RAM, the second tile being associated with the given instrument, the given side, and a second price;
determining whether the first tile comprises any active access nodes in the one or more prioritized collections in the first tile;
locating in the Block RAM the requested second access node in the second tile, the locating further comprising locating in the Block RAM in a prioritized collection of the one or more prioritized collections in the second tile the second access node via one or more head and/or tail references in the second tile; and
returning from the Block RAM the second requested access node from the second tile loaded in the Block RAM.

25. The system of claim 24, wherein the one or more data processors are configured to start loading the second tile prior to receiving the second request for the second access node.

26. The system of claim 20, wherein:
each access node is uniquely identified by the given ISP and an index value into the array of access nodes;
receiving a request for an access node at a given ISP further comprises receiving a request for an access node at a given ISP and a given index value, the request for the access node being associated with an order cancel request; and
locating in the Block RAM the requested access node in the tile for the given ISP further comprises locating in the Block RAM the access node having the given index value in the array of access nodes.

27. The system of claim 19, wherein loading the tile for the given ISP from the DRAM into the Block RAM is performed prior to receiving a request for an access node at the given ISP.
